(19) United States
(12) Patent Application Publication
(10) Pub. No.: US 2019/0001549 A1
(43) Pub. Date: Jan. 3, 2019

(54) RECESS-AND-PROTRUSION-FORMED BODY

(71) Applicant: KABUSHIKI KAISHA TOKAI-RIKA-DENKI-SEISAKUSHO, Aichi (JP)

(72) Inventor: Mitsuru NARUSE, Aichi (JP)

(21) Appl. No.: 16/124,437

(22) Filed: Sep. 7, 2018

Related U.S. Application Data
(62) Division of application No. 15/550,802, filed on Aug. 14, 2017.

(30) Foreign Application Priority Data
Feb. 24, 2015 (JP) 2015-034371

(51) Int. Cl. B29C 59/16; B23K 26/00; B29C 59/00; B23K 26/354; B23K 26/359

(52) U.S. Cl. CPC B29C 59/16; B23K 26/0006; B29C 2791/009; B29K 2101/12; B23K 26/354; B23K 26/359; B29C 59/002

(57) ABSTRACT

In a groove-formed body, recesses and protrusions are formed in a resin plate by irradiating a laser. Each of four recesses extend from an intersection point thereof. When forming each of the recesses in the resin plate, a portion at the intersection point of the recesses is an irradiation stop position of the laser, and an amount of heat generated by the laser on the resin plate is decreased. This enables a protrusion to be suppressed from being formed on either side of the intersection point of the recesses, and enables a protrusion to be suppressed from being disposed between the portion of the recesses at the intersection point, and a portion other than at the intersection point.

### TECHNICAL FIELD

The present invention relates to a recess-and-protrusion-formed body in which a protrusion is disposed at the side of a recess.

### BACKGROUND ART

In a packaging material described by Japanese Patent Application Laid-Open (JP-A) No. H10-287361, a recess is formed in a molecular-oriented thermoplastic resin layer and protrusions are formed at the sides of the recess by irradiating a laser onto the molecular-oriented thermoplastic resin layer.

In this packaging material, suppose two recess-and-protrusion sets were to be formed intersecting each other in the molecular-oriented thermoplastic resin layer. In such a case, even were one recess-and-protrusion set to be formed before forming the other recess-and-protrusion set, when forming the other recess-and-protrusion set, it would be difficult to eliminate the protrusions of the one recess-and-protrusion set at a portion intersecting with the one recess-and-protrusion set. Thus, the protrusions of the one recess-and-protrusion set are liable to remain between the portion at the intersection point of the pair of recesses, and a portion of the other recess other than at the intersection point.

### SUMMARY OF INVENTION

### Technical Problem

In consideration of the above circumstances, an object of the present invention is to enable a protrusion to be suppressed from being disposed between a portion of a recess at an intersection point and a portion other than at the intersection point.

### Solution to Problem

A recess-and-protrusion-formed body of a first aspect of the present invention includes a resin body, recesses, and a protrusion. The resin body has thermoplastic properties. The recesses are formed in the resin body in a state extending from an intersection point of three or more of the recesses by irradiating a laser onto the resin body. A portion of each recess at the intersection point configures an irradiation start position or an irradiation stop position of the laser when forming the recess in the resin body. The protrusion is formed on the resin body at a side of each of the recesses by forming the recesses in the resin body.

A recess-and-protrusion-formed body of a second aspect of the present invention includes a resin body, recesses, and a protrusion. The resin body has thermoplastic properties. The recesses are formed in the resin body in a state extending from an intersection point of three or more of the recesses by irradiating a laser onto the resin body, and are configured such that an amount of heat generated by the laser on the resin body decreases at a portion of each recess at the intersection point when forming the recess in the resin body. The protrusion is formed on the resin body at a side of each of the recesses by forming the recesses in the resin body.

A recess-and-protrusion-formed body of a third aspect of the present invention is the recess-and-protrusion-formed body of the first aspect or the second aspect of the present invention, wherein an amount of heat generated by the laser on the resin body when forming the recess in the resin body gradually decreases on progression toward a side of each recess at the intersection point.

A recess-and-protrusion-formed body of a fourth aspect of the present invention is the recess-and-protrusion-formed body of any one of the first aspect to the third aspect of the present invention, wherein, when forming the recess in the resin body, the resin body is cooled at at least one of a time when the laser is irradiated onto the resin body or a time when irradiation of the laser onto the resin body is paused.

In the recess-and-protrusion-formed body of the first aspect of the present invention, the resin body has thermoplastic properties. The laser is irradiated onto the resin body to form the recesses in the resin body and to form the protrusions at the side of the recesses. The recesses are formed in the resin body in a state extending from the intersection point of three or more of the recesses.

The portion of each recess at the intersection point configures the irradiation start position or the irradiation stop position of the laser when forming the recess in the resin body. Thus, when forming the portion of each of the recesses at the intersection point, a protrusion can be suppressed from forming at the side of the recess at the portion of the recess at the intersection point, and a protrusion can be suppressed from being disposed between the portion of the recess at the intersection point and a portion other than at the intersection point.

In the recess-and-protrusion-formed body of the second aspect of the present invention, the resin body has thermoplastic properties. The laser is irradiated onto the resin body to form the recesses in the resin body and to form the protrusions at the side of the recesses. The recesses are formed in the resin body in a state extending from the intersection point of three or more of the recesses.

The amount of heat generated by the laser on the resin body decreases at the portion of the recesses at the intersection point when forming the recess in the resin body. Thus, when forming the portion of each of the recesses at the intersection point, a protrusion can be suppressed from forming at the side of the recess at the portion of the recess at the intersection point, and a protrusion can be suppressed from being disposed between the portion of the recess at the intersection point and a portion other than at the intersection point.

In the recess-and-protrusion-formed body of the third aspect of the present invention, the amount of heat generated by the laser on the resin body when forming the recess in the resin body gradually decreases on progression toward the intersection point side of the recesses. This enables abrupt change to a depth dimension of the recesses at the portions of the recesses at the intersection point to be suppressed.

In the recess-and-protrusion-formed body of the fourth aspect of the present invention, when forming the recess in the resin body, the resin body is cooled at at least one of a time when the laser is irradiated onto the resin body or a time when irradiation of the laser onto the resin body is paused. This enables ignition of a laser-irradiated portion of the resin body to be suppressed from occurring, and enables a depth dimension of the recesses and a height dimension of the protrusions to be made large.

### BRIEF DESCRIPTION OF DRAWINGS

FIG. 1 is a cross-section illustrating a groove-formed body according to an exemplary embodiment of the present invention.

FIG. 2 is a plan view illustrating the groove-formed body according to the exemplary embodiment of the present invention.

FIG. 3 is a perspective view illustrating formation of a groove in the groove-formed body according to the exemplary embodiment of the present invention.

### DESCRIPTION OF EMBODIMENTS

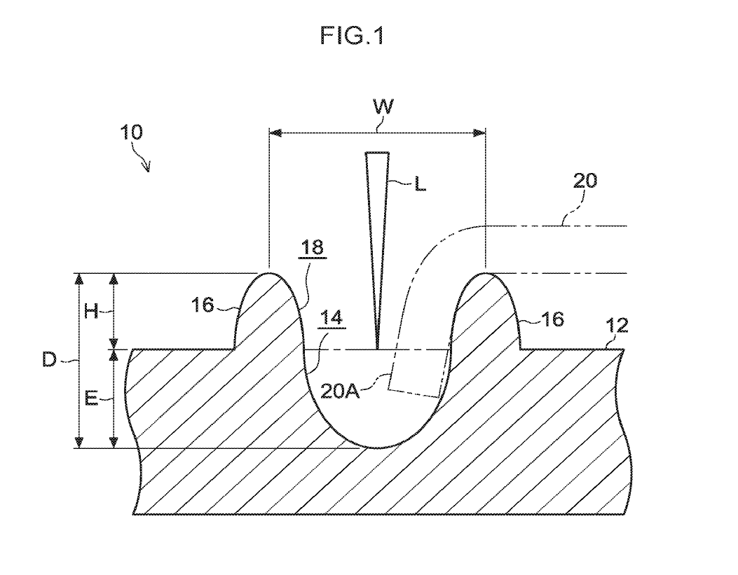

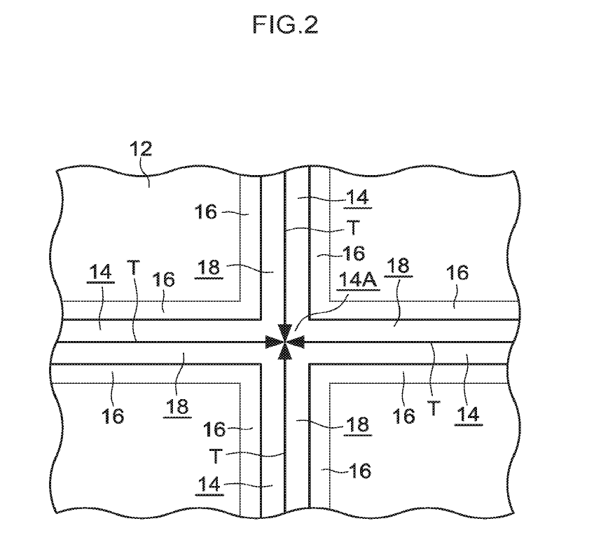

FIG. 1 is a cross-section illustrating a groove-formed body 10 (a recess-and-protrusion-formed body) according to an exemplary embodiment of the present invention. FIG. 2 is a plan view illustrating the groove-formed body 10.

The groove-formed body 10 according to the present exemplary embodiment is, for example, configured as a wheel cap, this being a vehicle component. The groove-formed body 10 is attached to a vehicle width direction outside of a wheel of a vehicle (not illustrated in the drawings).

As illustrated in FIG. 1 and FIG. 2, the groove-formed body 10 includes a plate shaped resin plate 12 serving as a resin body. The resin plate 12 is configured by, for example, a PP resin, a PC resin, an ABS resin, a PC-ABS resin, or a PA resin. The resin plate 12 has thermoplastic properties. The resin plate 12 is set with a large thickness dimension of, for example, 1.5 mm, such that the resin plate 12 has high rigidity and also has high strength against cracking, bending, twisting, and the like.

Four (three or more is sufficient) recesses 14, each with a substantially semielliptical shaped cross-section, are formed in a front face (design face) of the resin plate 12, and each recess 14 extends, from an intersection point 14A, in a straight line along the front face of the resin plate 12. At both sides of a portion of each recess 14 other than at the intersection point 14A, a protrusion 16 with a substantially semielliptical shaped cross-section is formed on the front face of the resin plate 12. Each protrusion 16 extends along the recess 14. Thus, a groove 18 is formed in the front face of the resin plate 12, with the groove 18 being formed inside the recess 14 and between the protrusions 16. A depth dimension D of the groove 18 is configured by the sum of a depth dimension E of the recess 14 and a height dimension H of the protrusions 16. Note that, for example, the depth dimension D of the groove 18 is 0.1 mm or greater (for example, 0.1 mm), and a width dimension W (dimension between apex portions of the protrusions 16) of the groove 18 is 0.5 mm or greater (for example, 0.7 mm).

Further, a plate shaped mask 20, serving as a covering member, is mounted to the resin plate 12 from the front side prior to painting the front face of the resin plate 12, such that the mask 20 partially covers the front face of the resin plate 12. A hook portion 20A is formed at an end portion of the mask 20, and the hook portion 20A projects out toward the resin plate 12 side. Thus, the hook portion 20A catches onto the groove 18 of the resin plate 12 in a state in which the hook portion 20A is elastically deformed, thereby mounting the mask 20 onto the resin plate 12. The portion of the front face of the resin plate 12 that is covered by the mask 20 is thus restricted from being painted when the front face of the resin plate 12 is painted.

Next, explanation follows regarding operation of the present exemplary embodiment.

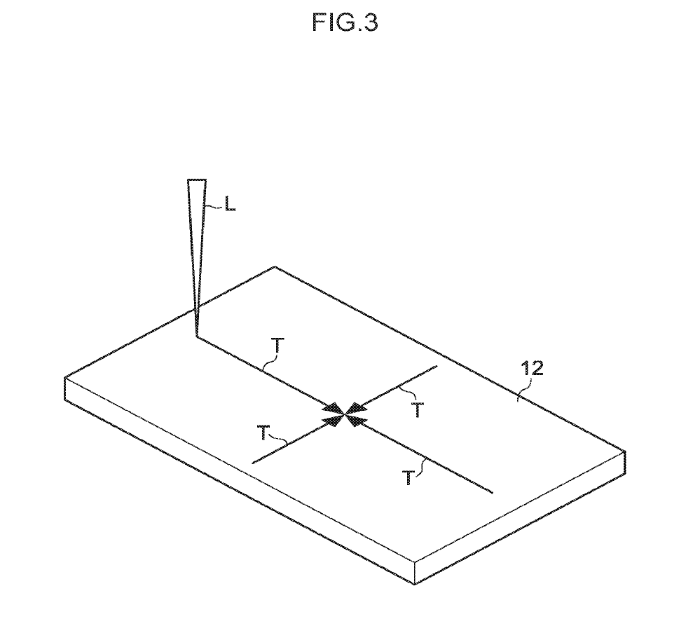

In the groove-formed body 10 configured as described above, when forming the groove 18 (the recess 14 and the protrusions 16) in the front face of the resin plate 12, as illustrated in FIG. 2 and FIG. 3, a laser L (laser light) is irradiated onto a formation position of the groove 18 in the resin plate 12 from the front side, such that the portion of the resin plate 12 where the laser L is irradiated is heated up, thereby melting or sublimating. The portion of the resin plate 12 where the laser L is irradiated is pressed and moved toward the front side of the resin plate 12 by vapor pressure, thereby forming the recess 14 in the front face of the resin plate 12 and forming the protrusions 16 on both sides of the recess 14, such that the groove 18 is formed. Further, the laser L is scanned along the front face of the resin plate 12, thereby forming the recess 14 and the protrusions 16 continuously along a scanning track T of the laser L so as to form the continuous groove 18.

Further, the laser L is a CO₂ laser. Moreover, when forming the groove 18 (the recess 14 and the protrusions 16) in the front face of the resin plate 12, the output of the laser L is, for example, no less than 1 W and no more than 10 W, and the spot diameter of the laser L is, for example, no less than 0.5 mm and no more than 2 mm. The scanning speed of the laser L is, for example, 5 m/minute or more. The laser L thus heats the resin plate 12 up to a temperature that is the melting point of the resin plate 12 or greater and less than the boiling point of the resin plate 12.

The four recesses 14 are formed in the front face of the resin plate 12, in a state respectively extending from the intersection point 14A.

Note that when forming each recess 14 in the front face of the resin plate 12, a portion of each recess 14 at the intersection point 14A configures an irradiation stop position (or irradiation start position) of the laser L. Thus, at the portion of each recess 14 at the intersection point 14A, the output of the laser L gradually decreases from a set output on progression toward the intersection point 14A side of each recess 14, such that the irradiation amount of the laser L, and by extension the amount of heat generated by the laser L on the resin plate 12, gradually decreases on progression toward the intersection point 14A side of the recesses 14. The protrusions 16 are thereby suppressed or prevented from forming on either side of the portion of the recess 14 at the intersection point 14A.

This enables the protrusions 16 to be suppressed or prevented from being disposed between the portion of the recess at the intersection point 14A and the portion of the recess other than at the intersection point 14A. Thus, even in cases in which the mask 20 is mounted onto the resin plate 12 with the hook portion 20A of the mask 20 caught on two or more of the continuous grooves 18 in the resin plate 12 through the intersection point 14A, any decrease caused by the protrusions 16 in the amount of catch of the hook portion 20A in the two or more grooves 18 can be suppressed or prevented, enabling paint to be prevented from straying from the mask 20.

As described above, when forming the respective recesses 14 in the front face of the resin plate 12, at the portion of each recess 14 at the intersection point 14A, the amount of heat generated by the laser L on the resin plate 12 decreases, and the depth dimension of the recesses 14 formed by the laser L is small. Thus, even when all of the recesses 14 have been formed in the front face of the entire resin plate 12, the depth dimension E of the recesses 14 can be suppressed from becoming large at the portions of the recesses 14 at the intersection point 14A, and the depth dimension E of the recesses 14 can be made uniform. Moreover, voids (bubbles) can be suppressed from forming at the portions of the recesses 14 at the intersection point 14A. This enables an improvement in the quality with which the recesses 14 are formed in the resin plate 12.

Moreover, as described above, when forming the respective recesses 14 in the front face of the resin plate 12, at the portions of the recesses 14 at the intersection point 14A, the amount of heat generated by the laser L on the resin plate 12 gradually decreases on progression toward the intersection point 14A side of each recess 14, and the depth dimension of the recesses 14 formed by the laser L gradually decreases on progression toward the intersection point 14A side of each recess 14. Thus, an abrupt change in the depth dimension E of the recesses 14 at the portions of the recesses 14 at the intersection point 14A can be suppressed, and the depth dimension E of the recesses 14 can be made even more uniform.

Note that when forming the respective recesses 14 in the front face of the resin plate 12, the laser L is repeatedly irradiated and scanned plural times onto the resin plate 12 (for example, three times or more) at the formation position of each recess 14. Accordingly, in the interval from when the laser L is irradiated and scanned at the formation position of the recess 14 in the resin plate 12 until the next time the laser L is irradiated and scanned at the formation position of the recess 14 in the resin plate 12, irradiation of the laser L onto the formation position of the recess 14 in the resin plate 12 is temporarily paused, and so the formation position of the recess 14 in the resin plate 12 is left to cool. Moreover, although the irradiation amount from the sum total of plural uses of the laser L onto the formation position of the recess 14 in the resin plate 12 may be large, the irradiation amount from each use of the laser L onto the formation position of the recess 14 in the resin plate 12 is small.

Accordingly, the laser L irradiated portion of the resin plate 12 can be suppressed from increasing sharply in temperature (overheating) and igniting, the depth dimension E of the recesses 14 and the height dimension H of the protrusions 16 can be made large, and the depth dimension D of the grooves 18 can be made large. Thus, when the mask 20 is mounted onto the resin plate 12, the amount of catch of the hook portion 20A of the mask 20 in the grooves 18 can be made large, enabling paint to be further prevented from straying from the mask 20.

Note that in the present exemplary embodiment, when forming the respective recesses 14 in the resin plate 12, at the portions of the recesses 14 at the intersection point 14A, the amount of heat generated by the laser L on the resin plate 12 gradually decreases on progression toward the intersection point 14A side of each recess 14. However, when forming the respective recesses 14 in the resin plate 12, it is sufficient that the amount of heat generated by the laser L on the resin plate 12 decrease at the portions of the recesses 14 at the intersection point 14A.

Moreover, in the present exemplary embodiment, when forming the respective recesses 14 in the front face of the resin plate 12, the output of the laser L at the portions of the recesses 14 at the intersection point 14A decreases, such that the irradiation amount of the laser L and hence the amount of heat generated by the laser L on the resin plate 12 is small. However, when forming the respective recesses 14 in the resin plate 12, configuration may be made in which at the portions of the recesses 14 at the intersection point 14A, the scanning speed of the laser L is increased, such that the irradiation amount of the laser L and hence the amount of heat generated by the laser L on the resin plate 12 is decreases.

Moreover, in the present exemplary embodiment, when forming the respective recesses 14 in the resin plate 12, the laser L is irradiated plural times onto the resin plate 12, such that when irradiation of the laser L onto the resin plate 12 is temporarily paused, the formation positions of the recesses 14 in the resin plate 12 are cooled. However, when forming the respective recesses 14 in the resin plate 12, it is sufficient that the formation positions of the recesses 14 in the resin plate 12 be cooled at at least one of a time when the laser L is irradiated onto the resin plate 12 and a time when irradiation onto the resin plate 12 by the laser L is temporarily paused. Moreover, configuration may be made in which either the resin plate 12 or the vicinity of the resin plate 12 is cooled (lowered in temperature) to cool the formation positions of the recesses 14 in the resin plate 12.

Moreover, in the present exemplary embodiment, the recesses 14 extend from the intersection point 14A in straight lines. However, the recess 14 may extend from the intersection point 14A in curved lines.

Further, in the present exemplary embodiment, an exothermic material (for example, carbon black) that absorbs the laser L and heats up may be mixed into the resin plate 12.

Moreover, in the present exemplary embodiment, the laser L is a CO₂ laser. However, the laser L may be a YGA laser, a YVO₄ laser, a fiber laser, a semiconductor laser, or a second harmonic laser generated from any these.

The disclosure of Japanese Patent Application No. 2015-34371 filed on Feb. 24, 2015 is incorporated in its entirety by reference herein.

### EXPLANATION OF THE REFERENCE NUMERALS

10 groove-formed body (recess-and-protrusion-formed body)
12 resin plate (resin body)
14 recess
14A intersection point
16 protrusion
L laser

1. A method for producing a recess-and-protrusion-formed body comprising:
providing a resin body having thermoplastic properties;
forming recesses that are each formed in the resin body in a state extending from an intersection point of three or more of the recesses by irradiating a laser onto the resin body, a portion at the intersection point being an irradiation start position or an irradiation stop position of the laser when forming the recess in the resin body; and
forming protrusions that are formed on the resin body at a side of the recesses by forming the recesses in the resin body, and
suppressing or preventing the formation of protrusions at the intersection point when forming said recesses by starting or stopping irradiation from the laser at the intersection point.

2. A method for producing a recess-and-protrusion-formed body comprising:
providing a resin body having thermoplastic properties;
forming recesses that are each formed in the resin body in a state extending from an intersection point of three or more of the recesses by irradiating a laser onto the resin body, with an amount of heat generated by the laser on the resin body decreased at a portion at the intersection point when forming the recess in the resin body; and
forming protrusions that are formed on the resin body at a side of the recesses by forming the recesses in the resin body, and
suppressing or preventing the formation of protrusions at the intersection point when forming said recesses by gradually decreasing the amount of heat generated by the laser on the resin body on progression toward an intersection point side of the recesses.

3. The method for producing a recess-and-protrusion-formed body of claim 1, wherein, when forming the recess in the resin body, the resin body is cooled at least one of a time when the laser is irradiated onto the resin body or a time when irradiation of the laser onto the resin body is paused.

4. The method for producing a recess-and-protrusion-formed body of claim 1, wherein the laser is repeatedly irradiated onto the resin body a plurality of times.

5. The method for producing a recess-and-protrusion-formed body of claim 1, wherein an exothermic material that absorbs a laser radiation and heats up is mixed into the resin body.

6. The method for producing a recess-and-protrusion-formed body of claim 1, wherein laser irradiation is stopped or started from the intersection point.

7. The method for producing a recess-and-protrusion-formed body of claim 2, wherein, when forming the recess in the resin body, the resin body is cooled at least one of a time when the laser is irradiated onto the resin body or a time when irradiation of the laser onto the resin body is paused.

8. The method for producing a recess-and-protrusion-formed body of claim 2, wherein the laser is repeatedly irradiated onto the resin body a plurality of times.

9. The method for producing a recess-and-protrusion-formed body of claim 2, wherein an exothermic material that absorbs laser radiation and heats up is mixed into the resin body.
